(19) United States
(12) Patent Application Publication
(10) Pub. No.: US 2011/0096261 A1
(43) Pub. Date: Apr. 28, 2011

(54) DISPLAY DEVICE

(75) Inventors: Kunpei KOBAYASHI, Tachikawa-shi (JP); Norihiro ARAI, Hino-shi (JP)

(73) Assignee: CASIO COMPUTER CO., LTD., Tokyo (JP)

(21) Appl. No.: 12/911,868

(22) Filed: Oct. 26, 2010

(30) Foreign Application Priority Data
Oct. 28, 2009 (JP) 2009-247930

(51) Int. Cl. G02F 1/1334; G02F 1/1368; G02F 1/1335; G02F 1/1343; G02F 1/13357

(52) U.S. Cl. 349/42

(57) ABSTRACT

A polymer dispersed liquid crystal display device includes a reflecting layer formed on a first substrate, a color separation layer formed on the reflecting layer, and a first electrode formed on the color separation layer. The device also includes second electrodes, switching thin film transistors, scanning lines, and signal lines, these components being formed on the second substrate. The second electrodes face the first electrode. The device also includes a liquid crystal layer arranged between the first electrode and the second electrodes. The liquid crystal layer includes a polymer dispersant and liquid crystal molecules. Each of the thin film transistors includes a gate electrode, source electrode and drain electrode. The scanning lines connect to the gate electrodes. The signal lines connect to corresponding one of source electrodes and drain electrodes. The other of the source electrodes and the drain electrodes connect to the corresponding second electrode.

### CROSS-REFERENCE TO RELATED APPLICATIONS

This application is based upon and claims the benefit of priority from prior Japanese Patent Application No. 2009-247930, filed Oct. 28, 2009, the entire contents of which are incorporated herein by reference.

### BACKGROUND OF THE INVENTION

1. Field of the Invention

The present invention relates to a display device and, more particularly, to a polymer dispersed liquid crystal display device.

2. Description of the Related Art

A liquid crystal display device is used in display panels for various application purposes because of its advantages, such as small thickness and low power consumption. As a general display mode of the liquid crystal display device, for example, a twisted nematic mode is known. In the twisted nematic mode, a liquid crystal panel includes two polarizing plates sandwiching a liquid crystal layer. The liquid crystal panel displays an image by controlling the amount of, out of light emitted by a backlight serving as a light source, light that passes through the two polarizing plates. Since the light absorption of the polarizing plates is high, a large amount of energy is necessary for realizing bright display using the polarizing plates.

On the other hand, a polymer dispersed liquid crystal display device as disclosed in, for example, Jpn. Pat. Appln. KOKAI Publication No. 5-224186 is known. This publication discloses a technique of controlling display by controlling an alignment of polymer-dispersed liquid crystal molecules in a liquid crystal layer based on an electric field generated by electrodes arranged so as to sandwich the liquid crystal layer, thereby changing the liquid crystal layer to a light transmission state or light scattering state. In this display scheme, the display device requires no polarizing plate. Since no light loss due to absorption by a polarizing plate occurs, light can be used effectively. Hence, bright display is possible.

The above-described polymer dispersed liquid crystal display device can employ various structures.

The structure is associated with the optical characteristic of the display device, and therefore largely influences the display quality. The structure also greatly affects the difficulty of manufacture.

### BRIEF SUMMARY OF THE INVENTION

According to an aspect of the invention, a polymer dispersed liquid crystal display device includes a reflecting layer formed on a first substrate; a color separation layer formed on the reflecting layer; a first electrode formed on the color separation layer; a plurality of second electrodes formed on a second substrate, the second electrodes facing the first electrode; a plurality of switching thin film transistors formed on the second substrate each including a gate electrode, a source electrode and a drain electrode; a plurality of scanning lines formed on the second substrate each connected to the gate electrodes of corresponding the switching thin film transistors configured to supply scanning signals for selectively turning the corresponding switching thin film transistors in an ON state; a plurality of signal lines formed on the second substrate each connected to one of the source electrodes and the drain electrodes of corresponding the switching thin film transistors configured to supply a data signal to the switching thin film transistors in the ON state, each of the other of the source electrodes and the drain electrodes being connected to corresponding one of the second electrodes; and a liquid crystal layer arranged between the first electrode and the second electrodes, the liquid crystal layer including a polymer dispersant and liquid crystal molecules, directions of the liquid crystal molecules being controlled by an electric field induced by the first electrode and the second electrodes.

According to another aspect of the invention, a polymer dispersed liquid crystal display device includes a reflecting layer formed on a first substrate; a color separation layer formed on the reflecting layer; a first electrode formed on the color separation layer; a plurality of second electrodes formed on a second substrate, the second electrodes facing the first electrode; a liquid crystal layer arranged between the first electrode and the second electrodes, the liquid crystal layer including a polymer dispersant and liquid crystal molecules; a plurality of switching thin film transistors formed on the second substrate each including a gate electrode, a source electrode and a drain electrode, each of the source electrodes being connected to corresponding one of the second electrodes; a scanning driver formed on the second substrate so as to sequentially output scanning signals to the switching thin film transistors via scanning lines for a predetermined period in order to turn the switching thin film transistors in an ON state, the scanning lines formed on the second substrate in parallel to each other and being connected to the gate electrodes of corresponding the switching thin film transistors; a signal driver formed on the second substrate so as to output data signals to the switching thin film transistors in the ON state via signal lines, the signal lines formed on the second substrate in parallel to each other with intersecting the scanning lines and being connected to the drain electrodes of corresponding the switching thin film transistors; and a controller which controls the scanning driver and the signal driver.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a schematic view showing an example of the arrangement of a display apparatus including a polymer dispersed liquid crystal display device according to an embodiment of the present invention;

FIG. 2 is a schematic sectional view showing an example of the structure of the polymer dispersed liquid crystal display device according to the embodiment of the present invention;

FIG. 3 is a schematic planar view showing an example of the structure of the polymer dispersed liquid crystal display device according to the embodiment of the present invention;

FIG. 4 is a view for explaining the display principle of the polymer dispersed liquid crystal display device according to the embodiment of the present invention and, more particularly, a case in which no voltage is applied to the pixel electrodes;

FIG. 5 is a view for explaining the display principle of the polymer dispersed liquid crystal display device according to the embodiment of the present invention and, more particularly, a case in which a voltage is applied to the pixel electrodes;

FIGS. 6A and 6B are views for explaining a parallax of the polymer dispersed liquid crystal display device according to the embodiment of the present invention, wherein FIG. 6A indicates a case in which a reflecting layer is provided on a side of a back substrate opposite to a liquid crystal layer and FIG. 6B indicates a case in which a reflecting layer is provided on the liquid crystal layer side of a back substrate; and

FIGS. 7A and 7B are schematic views showing a modification of the polymer dispersed liquid crystal display device according to the embodiment of the present invention so as to explain its display principle, wherein FIG. 7A indicates a case in which no voltage is applied to the pixel electrodes and FIG. 7B indicates a case in which a voltage is applied to the pixel electrodes.

### DETAILED DESCRIPTION OF THE INVENTION

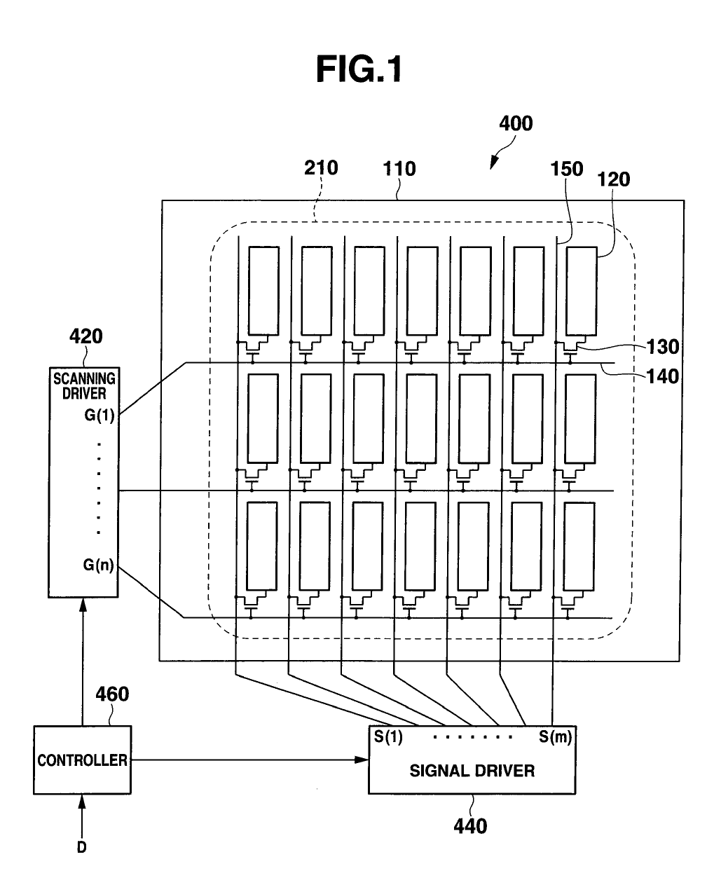

An embodiment of the present invention will be described with reference to the accompanying drawings. FIG. 1 is a view showing the arrangement of a display apparatus including a polymer dispersed liquid crystal display device according to this embodiment. As shown in FIG. 1, the display apparatus includes a display panel 400 that is the polymer dispersed liquid crystal display device according to the embodiment, a scanning driver 420, a signal driver 440, and a controller 460. The display panel 400 displays an image based on image data D supplied out of the display apparatus.

A plurality of scanning lines 140 (G(j) (j=1, 2, . . . , n)) and a plurality of signal lines 150 (S(i) (i=1, 2, . . . , m)) run so as to intersect each other on a front substrate 110 of the display panel 400. Pixel electrodes 120 are arranged respective positions corresponding to the intersections between the scanning lines 140 and the signal lines 150. The pixel electrodes 120 are electrically connected to the scanning lines 140 (G(j)) and the signal lines 150 (S(i)) via thin film transistors (TFTs) 130. Hence, m pixel electrodes 120 are connected to each scanning line, whereas n pixel electrodes 120 are connected to each signal line. Note that FIG. 1 schematically illustrates a range corresponding to n=3 and m=7 for the sake of simplicity. Color filters corresponding to red, green, and blue are provided on a back substrate 210 at positions corresponding to the pixel electrodes 120. The set of a pixel electrode 120 and a color filter form a sub pixel of one color. Three sub pixels of red, green, and blue form one pixel. That is, one pixel has three pixel electrodes that form three sub pixels.

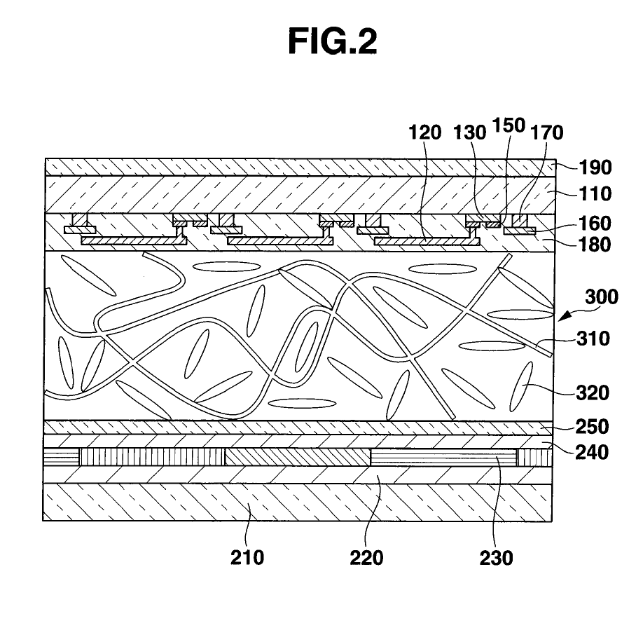

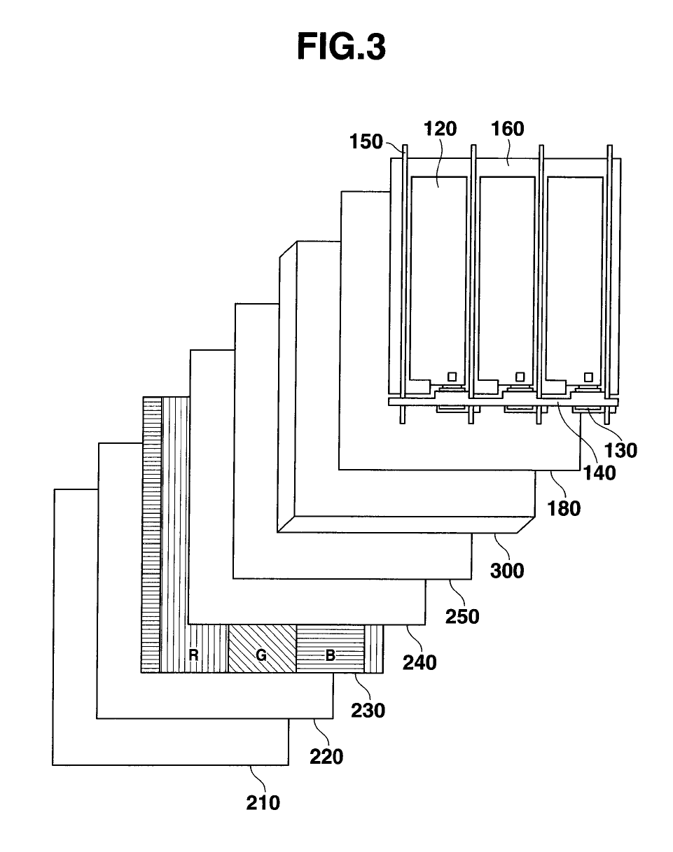

An example of the structure of one pixel of the display panel 400 that is the polymer dispersed liquid crystal display device according to the embodiment will be described in more detail with reference to FIGS. 2 and 3. FIG. 2 is a sectional view, and FIG. 3 is a exploded planar view. As shown in FIGS. 2 and 3, a reflecting layer 220 is formed on the back substrate 210. The back substrate 210 includes, for example, a glass substrate. The reflecting layer 220 includes, for example, an aluminum film. Color filters 230 including red, green, and blue are formed on the reflecting layer 220. As described above, a block including one color filter 230 is called a sub pixel. A total of three sub pixels including three, i.e., red, green, and blue color filters 230, respectively, form one pixel. An opposed electrode 240 formed from a transparent conductive film is formed on the color filters 230. The opposed electrode 240 may include, for example, an indium tin oxide (ITO) film. A surface stabilizing layer 250 is formed on the opposed electrode 240.

The pixel electrodes 120 made of, for example, ITO are formed on the front substrate 110 that is a transparent substrate such as a glass substrate. The pixel electrodes 120 are formed for the respective sub pixels in correspondence with the color filters 230. Each pixel electrode 120 is connected to the source electrode (or drain electrode) of a corresponding TFT 130 serving as a switching element. The scanning lines 140 are connected to the gate electrodes of the TFTs 130. The signal lines 150 are connected to the drain electrodes (or source electrodes) of the TFTs 130. As described above, the scanning lines 140 and the signal lines 150 intersect at right angles. A compensatory capacity electrode 160 is formed between the front substrate 110 and each pixel electrode 120. Each compensatory capacity electrode 160 is connected to a compensatory capacity line 170. A surface stabilizing layer 180 is formed on these structures.

A surface of the back substrate 210 on the side of the surface stabilizing layer 250 and a surface of the front substrate 110 on the side of the surface stabilizing layer 180 are bonded via a gap material (not shown) so as to form a uniform gap. A liquid crystal layer 300 formed by dispersing liquid crystal molecules 320 in a polymer network 310 is sealed in the gap. An optical film 190 for anti-reflection or the like is bonded to a surface of the front substrate 110 on the side opposite to the liquid crystal layer 300.

Note that in this embodiment, the reflecting layer 220 is uniformly solidly formed all over a portion of the back substrate 210 with the pixels. Similarly, the opposed electrode 240 is uniformly solidly formed all over a portion of the color filters 230 with the pixels. The surface stabilizing layer 180 and 250 act to, for example, prevent an electrical short circuit between the opposed electrode 240 and the pixel electrodes 120, and prevent that the liquid crystal molecules 320 existing on the interface from aligning in a specific direction. The surface stabilizing layer 250 is also uniformly solidly formed all over a portion of the opposed electrode 240 with the pixels. Similarly, the surface stabilizing layer 180 is uniformly solidly formed all over a portion of the pixel electrodes 120 with the pixels.

As described above, for example, the reflecting layer 220 functions as a reflecting layer formed on a first substrate. For example, the color filters 230 function as a color separation layer formed on the reflecting layer. For example, the opposed electrode 240 functions as a first electrode formed on the color separation layer. For example, the pixel electrode 120 functions as a second electrode formed on a second substrate. The TFT 130 functions as a switching thin film transistor connected to the second electrode. For example, the scanning line 140 functions as a scanning line which supplies a scanning signal to selectively turn on the switching thin film transistor to its gate electrode. For example, the signal line 150 functions as a signal line which inputs a data signal to, out of the switching thin film transistors in an ON state, a switching thin film transistor connected to the second electrode that should align liquid crystal molecules. For example, the liquid crystal layer 300 functions as a liquid crystal layer including the liquid crystal molecules 320 and the polymer network 310, the polymer network 310 functioning as a polymer dispersant.

The operation of the polymer dispersed liquid crystal display device according to this embodiment will be described next. Under the control of the controller 460, the scanning driver 420 shown in FIG. 1 sequentially supplies scanning signals to the scanning lines 140 (G(j)) of the display panel 400. When the scanning signals are supplied to the scanning lines 140, the TFTs 130 connected to the scanning lines 140 are turned on. At this time, the signal driver 440 supplies data signals to the signal lines 150 (S(i)) under the control of the controller 460. The data signals supplied to the signal lines 150 (S(i)) are supplied to the corresponding pixel electrodes 120 via the TFTs 130 turned on by the scanning signals. In this way, the scanning signals are sequentially supplied to the scanning lines 140, and simultaneously, the data signals are supplied to the signal lines 150 to which pixel voltages should be applied. This makes it possible to apply the pixel voltages to desired pixel electrodes 120 of all the pixel electrodes. On the other hand, the opposed electrode 240 is maintained at a predetermined voltage. The compensatory capacity electrodes 160 located under the pixel electrodes 120 are also maintained at an equi-voltage to the opposed electrode 240. Hence, the pixel electrodes 120 and the compensatory capacity electrodes 160 form storage capacitances. The storage capacitances retain the pixel voltages based on the data signals supplied to the pixel electrodes 120.

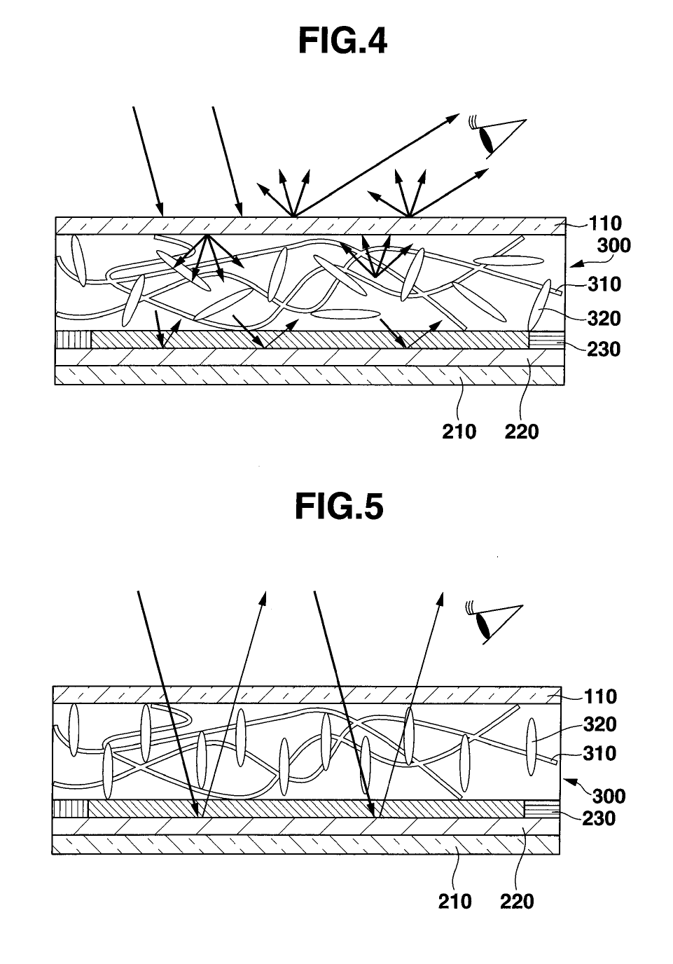

The display principle of the polymer dispersed liquid crystal display device according to the embodiment will be described here with reference to FIGS. 4 and 5. FIGS. 4 and 5 do not illustrate light refraction at the interface of each component for the sake of simplicity. Without an electric field between the pixel electrode 120 and the opposed electrode 240, the liquid crystal molecules 320 dispersed in the polymer network 310 point in arbitrary directions, as shown in FIG. 4. In this case, when the refractive index of the polymer network 310 is different from the average refractive index of the liquid crystal molecules 320, light that enters from the side of the front substrate 110 passes through the liquid crystal layer 300 with scattering. The scattered light passes through the color filter 230 on the back substrate 210, and is reflected by the reflecting layer 220 behind the color filter 230. Note that the light that passes through the color filter 230 is attenuated by the color filter 230. The light that passes through the color filter 230 and is reflected by the reflecting layer 220 has a color. The colored light passes through the liquid crystal layer 300 again while scattering, and exits from the front substrate 110 as scattered light. Hence, light that enters the liquid crystal layer 300 in which the liquid crystal molecules 320 point in arbitrary directions exits from the side of the front substrate 110 as colored light while scattering. The colored light is observed from various angles on the side of the front substrate 110.

On the other hand, when a sufficiently large electric field is formed between the pixel electrode 120 and the opposed electrode 240, the liquid crystal molecules 320 dispersed in the polymer network 310 are aligned in one direction in accordance with the generated electric field, as shown in FIG. 5. In this case, when the refractive index of the polymer network 310 is the same as the refractive index of the liquid crystal molecules 320 aligned in one direction, light that enters from the side of the front substrate 110 travels straight in the liquid crystal layer 300, passes through the color filter 230, and is regularly reflected by the reflecting layer 220 behind the color filter 230. The light passes through color filter 230 again, travels straight in the liquid crystal layer 300, and exits from the front substrate 110. Note that the light is attenuated as it passes through the color filter 230. In the above-described way, light that enters the liquid crystal layer 300 in which the liquid crystal molecules 320 are aligned in one direction linearly exits from the side of the front substrate 110 as colored light. Hence, although the light is observed from the direction of optical path as light having a weak color, the light is not observed from other directions and appears black.

The display device can thus display red, green, blue, or black for each sub pixel. Note that adjusting the electric field formed between the pixel electrode 120 and the opposed electrode 240 allows to set the liquid crystal molecules 320 to an intermediate state between the state in which a sufficiently large electric field is formed between the pixel electrode 120 and the opposed electrode 240 and the state in which no electric field is formed. It is therefore possible to variously change the degree of scattering of light that passes through the liquid crystal layer 300 for each pixel. Hence, when the sub pixels are arranged in a matrix, the display apparatus including the polymer dispersed liquid crystal display device can display a full-color image.

According to this embodiment, it is possible to implement a reflection-type display device capable of display easy on eyes at high reflectance and contrast. According to this embodiment, a display device capable of bright display can be implemented. For example, a twisted nematic liquid crystal display device uses polarizing plates. However, the light absorption of the polarizing plates is very high. On the other hand, the polymer dispersed liquid crystal display device according to the embodiment uses no polarizing plate. Hence, the display device according to the embodiment can perform bright display as compared to the twisted nematic liquid crystal display device.

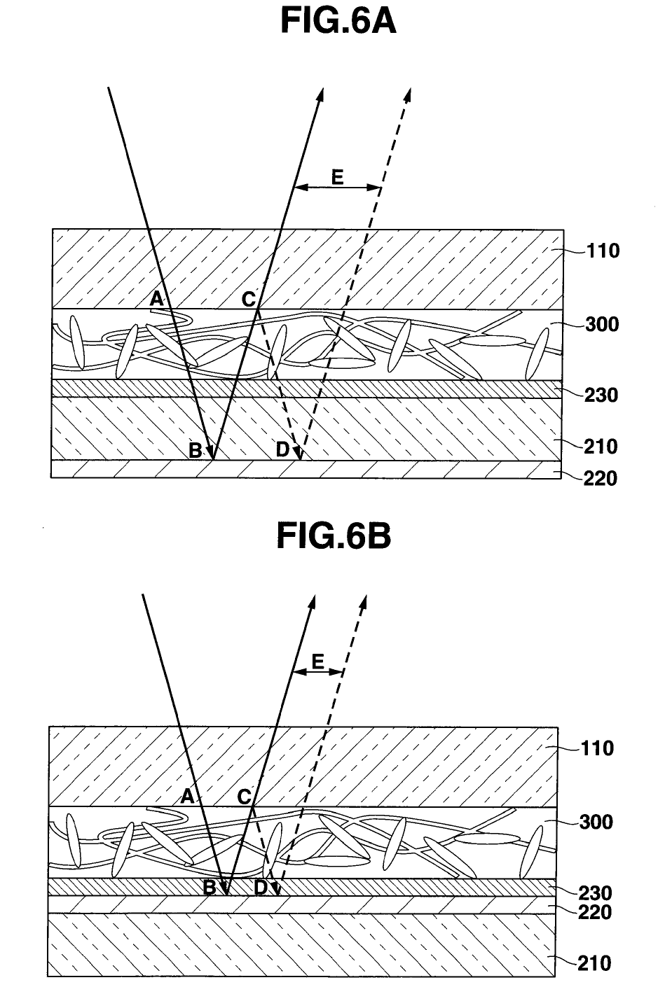

In this embodiment, the reflecting layer 220 is formed not behind the back substrate 210 (i.e., outside the panel; FIG. 6A) but on the front side of the back substrate 210 immediately behind the color filter 230 (i.e., inside the panel; FIG. 6B). As indicated by the solid arrows in FIGS. 6A and 6B, light that enters a scattering start point A passes through the color filter 230, is reflected at a first reflecting point B on the reflecting layer 220, passes through a scattering end point C, and reaches the observer. The light is a real image. At this time, as indicated by the dashed arrows in FIGS. 6A and 6B, the light that propagates from the scattering end point C to the reflecting layer 220 and is reflected at a second reflecting point D on the reflecting layer 220 also reaches the observer. This light appears as glare on the reflecting layer 220, i.e., a virtual image. Hence, the observer views a double image. The larger the shift amount between the real image and the virtual image is, the lower the display quality is. As can be seen by the shift amount E between the real image and the virtual image shown in FIGS. 6A and 6B, the shift amount between the real image and the virtual image generated by the thickness of the back substrate 210 is smaller in the display device of this embodiment shown in FIG. 6B than in the display device shown in FIG. 6A which has the reflecting layer 220 behind the back substrate 210. This improves the display quality of the display device according to the embodiment. Note that FIGS. 6A and 6B do not illustrate refraction of light at the interface of each layer for the sake of simplicity.

The opposed electrode 240 may be formed, for example, between the color filter 230 and the reflecting layer 220. Alternatively, the opposed electrode 240 may be formed between the color filter 230 and the back substrate 210 using a reflecting material so as to serve as the reflecting layer 220. However, if a structure exists between the opposed electrode 240 and the liquid crystal layer 300, the electric field formed in the liquid crystal layer 300 becomes relatively weak. In addition, the structure between the opposed electrode 240 and the liquid crystal layer 300 electrically has a capacitance component. This complicates control of the electric field formed in the liquid crystal layer 300. In this embodiment, to increase the strength of the electric field formed on the liquid crystal layer 300 and facilitate its control, the opposed electrode 240 is disposed near the liquid crystal layer 300.

The reflecting layer 220 and the opposed electrode 240 are uniformly solidly formed all over portions of the back substrate 210 and the color filter 230 with the pixels, respectively. Uniformly forming the reflecting layer 220 and the opposed electrode 240 all over a surface facilitates their manufacture and improves the manufacturing yield.

Also, in this embodiment, a polymer material to be cured by UV irradiation is used as the polymer network 310. When using a material to be cured by light irradiation in the manufacture of the display device, first, the back substrate 210 on which the opposed electrode 240 and the like are formed is bonded to the front substrate 110 on which the pixel electrodes 120 and the like are formed. Next, the monomer of a material as the prospective polymer network 310 and the liquid crystal molecules 320 are sealed. Finally, light irradiation is performed to form the polymer network 310. At this time, since the reflecting layer 220 does not pass light, the liquid crystal layer 300 cannot be irradiated with light from the side of the back substrate 210. Hence, the liquid crystal layer 300 is irradiated with light from the side of the front substrate 110. If the color filters 230 exist on the side of the front substrate 110, the color filters 230 absorb the irradiation light, and sufficient formation of the polymer network 310 is impossible. Hence, the arrangement in which the color filters 230 are not provided on the side of the front substrate 110 but formed on the reflecting layer 220, as in this embodiment, is suitable for the manufacture of the polymer dispersed liquid crystal display device.

Note that in the manufacture using the polymer material to be cured by UV light, if polymerization of the polymer material is insufficient, the unpolymerized monomer is gradually polymerized over time after the manufacture of the display device. This results in degradation in the performance of the polymer dispersed liquid crystal display device. To prevent the degradation, a UV screening filter is preferably included in the optical film 190.

In this embodiment, since the reflecting layer 220 and the color filters 230 are formed on the back substrate 210 for the above-described reasons, the TFTs 130 are formed on the side of the front substrate 110 separately. That is, separately manufacturing the structures on the sides of the back substrate 210 and the front substrate 110 and bonding them enable to facilitate the manufacture of each structure and improve the yield. In addition, bonding non-defective units on the sides of the back substrate 210 and the front substrate 110 allows to improve the entire yield.

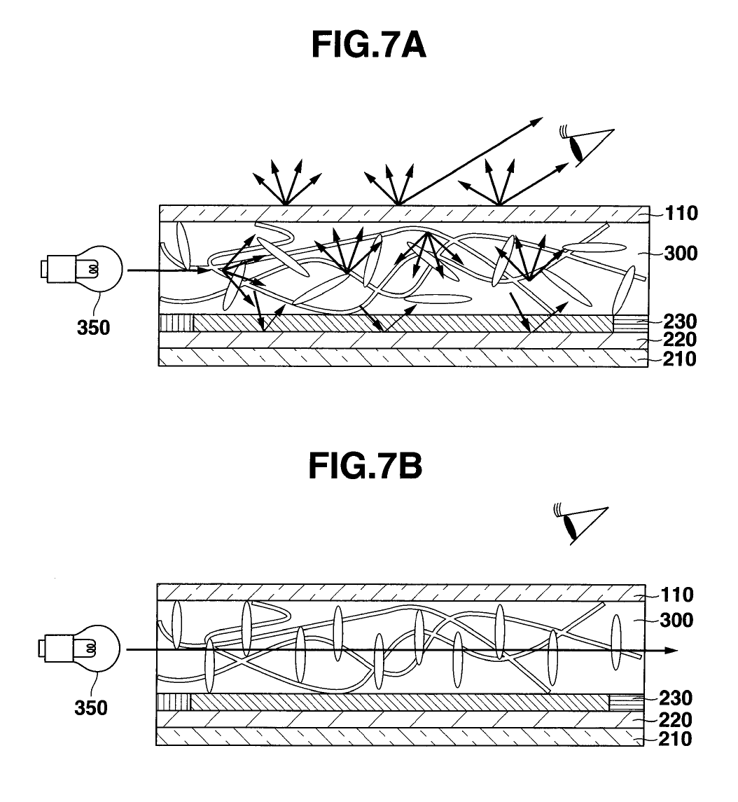

A modification of the embodiment will be explained next with reference to the accompanying drawings. Differences from the above-described embodiment will be described here. The same reference numerals as in the above-described embodiment denote the same parts, and a description thereof will not be repeated. The display device of the embodiment is a reflection-type polymer dispersed liquid crystal display device using external light. In contrast, a polymer dispersed liquid crystal display device according to the modification includes a side light 350 serving as a light source formed from, for example, a light-emitting diode (LED) on a side surface of the liquid crystal layer 300 of the display device, as shown in FIGS. 7A and 7B. In this display device, when no electric field is applied between the pixel electrode 120 and the opposed electrode 240, the liquid crystal molecules 320 in the liquid crystal layer 300 point in arbitrary directions, as shown in FIG. 7A. Hence, if the refractive index of the polymer network 310 is different from the average refractive index of the liquid crystal molecules 320, light that enters from the side light 350 on the side surface scatters so that light reflected by the reflecting layer 220 behind the color filter 230 of the pixel reaches the observer. On the other hand, when an large electric field is applied between the pixel electrode 120 and the opposed electrode 240, the liquid crystal molecules 320 in the liquid crystal layer 300 are aligned in one direction, as shown in FIG. 7B. When the refractive index of the polymer network 310 is the same as the refractive index of the liquid crystal molecules 320 aligned in one direction, light that enters travels straight and passes through the liquid crystal layer 300. Hence, the light that passes through the liquid crystal layer 300 does not reach the observer. Based on the above-described principle, the polymer dispersed liquid crystal display device of this modification can display an image.

According to the modification, the polymer dispersed liquid crystal display device can implement display observable even in a dark place without external incident light. In addition, since the light source is arranged on a side of the display surface of the display device, the entire display device can be designed thin.

In the polymer dispersed liquid crystal display device of the modification as well, since no polarizing plate is used, light loss is small. It is therefore possible to implement high-contrast display while saving energy. The same effects as in the above-described embodiment can also be obtained.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A polymer dispersed liquid crystal display device comprising:
a reflecting layer formed on a first substrate;
a color separation layer formed on the reflecting layer;
a first electrode formed on the color separation layer;
a plurality of second electrodes formed on a second substrate, the second electrodes facing the first electrode;
a plurality of switching thin film transistors formed on the second substrate each including a gate electrode, a source electrode and a drain electrode;
a plurality of scanning lines formed on the second substrate each connected to the gate electrodes of corresponding the switching thin film transistors configured to supply scanning signals for selectively turning the corresponding switching thin film transistors in an ON state;
a plurality of signal lines formed on the second substrate each connected to one of the source electrodes and the drain electrodes of corresponding the switching thin film transistors configured to supply a data signal to the switching thin film transistors in the ON state, each of the other of the source electrodes and the drain electrodes being connected to corresponding one of the second electrodes; and
a liquid crystal layer arranged between the first electrode and the second electrodes, the liquid crystal layer including a polymer dispersant and liquid crystal molecules, directions of the liquid crystal molecules being controlled by an electric field induced by the first electrode and the second electrodes.

2. The device according to claim 1, wherein the reflecting layer is solidly formed on a surface of the first substrate facing the liquid crystal layer.

3. The device according to claim 2, wherein the first electrode is solidly formed on a surface of the color separation layer facing the liquid crystal layer.

4. The device according to claim 3, further comprising:
a first surface stabilizing layer solidly formed on a surface of the first electrode facing the liquid crystal layer; and
a second surface stabilizing layer solidly formed on a surface of the second electrodes facing the liquid crystal layer.

5. The device according to claim 4, further comprising an anti-reflection film formed on the second substrate, the anti-reflection film being formed on a side opposite to a side arranged the liquid crystal layer.

6. The device according to claim 5, further comprising a UV screening film formed on the second substrate, the UV screening film being formed on the side opposite to the side facing the liquid crystal layer.

7. The device according to claim 1, further comprising a light source arranged in a planar direction outside the liquid crystal layer so as to irradiate the liquid crystal layer with light.

8. The device according to claim 7, wherein the light source comprises a side light formed from a light-emitting diode.

9. A polymer dispersed liquid crystal display device comprising:
a reflecting layer formed on a first substrate;
a color separation layer formed on the reflecting layer;
a first electrode formed on the color separation layer;
a plurality of second electrodes formed on a second substrate, the second electrodes facing the first electrode;
a liquid crystal layer arranged between the first electrode and the second electrodes, the liquid crystal layer including a polymer dispersant and liquid crystal molecules;
a plurality of switching thin film transistors formed on the second substrate each including a gate electrode, a source electrode and a drain electrode, each of the source electrodes being connected to corresponding one of the second electrodes;
a scanning driver formed on the second substrate so as to sequentially output scanning signals to the switching thin film transistors via scanning lines for a predetermined period in order to turn the switching thin film transistors in an ON state, the scanning lines formed on the second substrate in parallel to each other and being connected to the gate electrodes of corresponding the switching thin film transistors;
a signal driver formed on the second substrate so as to output data signals to the switching thin film transistors in the ON state via signal lines, the signal lines formed on the second substrate in parallel to each other with intersecting the scanning lines and being connected to the drain electrodes of corresponding the switching thin film transistors; and
a controller which controls the scanning driver and the signal driver.

10. The device according to claim 9, wherein the reflecting layer is solidly formed on a surface of the first substrate facing the liquid crystal layer.

11. The device according to claim 10, wherein the first electrode is solidly formed on a surface of the color separation layer facing the liquid crystal layer.

12. The device according to claim 11, further comprising:
a first surface stabilizing layer solidly formed on a surface of the first electrode facing the liquid crystal layer; and
a second surface stabilizing layer solidly formed on a surface of the second electrodes facing the liquid crystal layer.

13. The device according to claim 12, further comprising an anti-reflection film formed on the second substrate, the anti-reflection film being formed on a side opposite to a side arranged the liquid crystal layer.

14. The device according to claim 13, further comprising a UV screening film formed on the second substrate, the UV screening film being formed on the side opposite to the side facing the liquid crystal layer.

15. The device according to claim 9, further comprising a light source arranged in a planar direction outside the liquid crystal layer so as to irradiate the liquid crystal layer with light.

16. The device according to claim 15, wherein the light source comprises a side light formed from a light-emitting diode.
